(19) United States
(12) Patent Application Publication
(10) Pub. No.: US 2008/0012294 A1
(43) Pub. Date: Jan. 17, 2008

(54) Pipe Connector

(76) Inventor: Chia-Chun Cheng, Chung-Ho City (TW)

Correspondence Address: HDSL, 4331 STEVENS BATTLE LANE, FAIRFAX, VA, 22033, US

(21) Appl. No.: 11/466,733

(22) Filed: Aug. 23, 2006

(30) Foreign Application Priority Data
Oct. 18, 2005 (TW) 094217957

(51) Int. Cl. F16L 27/00

(52) U.S. Cl. 285/190

(57) ABSTRACT

A pipe connector includes a pipe-connecting piece hollowed in its interior, a pipe-covering piece covered on the pipe-connecting piece, and a sealing piece detachably provided on the outside of one end of the pipe-covering piece. The pipe-connecting piece has a first connecting port for communicating with its interior. At least one through hole is provided on the pipe-connecting piece for communicating with its interior. Further, two leakage-proof washers are provided at an interval with the through hole disposed therebetween. The pipe-covering piece has an annular sheath and a second connecting port provided on the outer wall of the annular sheath. The annular sheath is covered on the pipe-connecting piece to allow its inner wall to tightly contact with the two leakage-proof washers, so that the second connecting port is in communication with the interior of the pipe-connecting piece.

### BACKGROUND OF THE INVENTION

1. Field of the Invention

The present invention relates to a pipe connector, and in particular to a pipe connector applied to a water-cooling circulation system. Such a pipe connector is replaceable and capable of changing the orientation of the cold water pipeline by its rotation.

2. Description of Prior Art

Recently, various water-cooling circulation systems are proposed to perform the heat dissipation of a heat source by means of water-cooling actions. A cooling liquid such as cold water is injected into a water tank. The water tank is in fluid communication with a hollow cooling plate via the cold water pipeline. Meanwhile, with a pump, the cooling liquid within the water tank can be delivered into the cooling plate via the cold water pipeline. The cooling plate is used to contact face-to-face with the heat source. In this way, the cooling liquid carries away the heat generated by the heat source, so that the environment can be kept under a suitable temperature.

In using such kind of water-cooling circulation system, however, the problem most often encountered is the difficulty in replacing and repairing the cold water pipeline. Usually, in order to avoid the leakage of the cooling liquid, the intake/drain ports of the cold water pipeline and cooling plate are fixedly welded with pipe connectors. As a result, it is very difficult to perform the replacement. Even, the orientation of the cold water pipeline cannot be changed by its rotation. Therefore, the whole arrangement of the water-cooling circulation system will be restricted by the orientation of the cold water pipeline.

In view of the above, the inventor proposes the present invention to overcome the above problems based on his expert experiences and deliberate researches.

### SUMMARY OF THE INVENTION

The present invention is to provide a pipe connector, which is convenient to perform its detachment, replacement and repair and can be changed to correspond to different amount of water flow. Further, the orientation of the cold water pipeline can be changed, so that the whole arrangement of the water-cooling circulation system will be not restricted by the orientation of the pipeline.

The present invention provides a pipe connector, which is applied to a water-cooling circulation system and assembled between each intake/drain port of the water-cooling circulation system and the cold water pipeline. The pipe connector includes a pipe-connecting piece hollowed in its interior, a pipe-covering piece covered on the pipe-connecting piece, and a sealing piece detachably provided on the outside of one end of the pipe-covering piece. The pipe-connecting piece has a first connecting port in communication with its interior. At least one through hole is provided on the pipe-connecting piece for communicating with its interior. Further, two leakage-proof washers are provided at an interval with the through hole disposed therebetween. The pipe-covering piece has an annular sheath and a second connecting port provided on the outer wall of the annular sheath. The annular sheath is covered on the pipe-connecting piece to allow its inner wall to tightly contact with the two leakage-proof washers, so that the second connecting port is in communication with the interior of the pipe-connecting piece.

### BRIEF DESCRIPTION OF THE DRAWINGS

FIG. 1 is a perspective view showing that the present invention is applied to a water-cooling circulation system;

FIG. 2 is an exploded perspective view of the present invention;

FIG. 3 is an assembled perspective view of the present invention;

FIG. 4 is a cross-sectional plan view of the present invention;

FIG. 5 is a schematic view showing that the pipe-covering piece of the present invention has changed its orientation via its rotation;

FIG. 6 is an exploded perspective view showing the pipe-covering piece and cold water pipeline in accordance with another embodiment of the present invention; and

FIG. 7 is an exploded perspective view showing the pipe-connecting piece and sealing piece in accordance with another embodiment of the present invention

### DETAILED DESCRIPTION OF THE INVENTION

In order to make the Examiner better understand the characteristics and the technical contents of the present invention, a detailed description will be made with reference to the accompanying drawings. However, it should be understood that the drawings are illustrative but not used to limit the scope of the present invention.

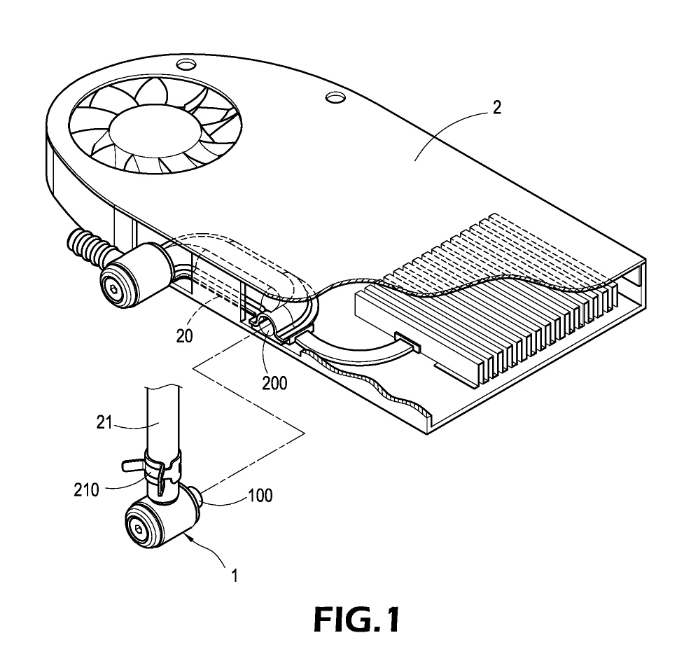

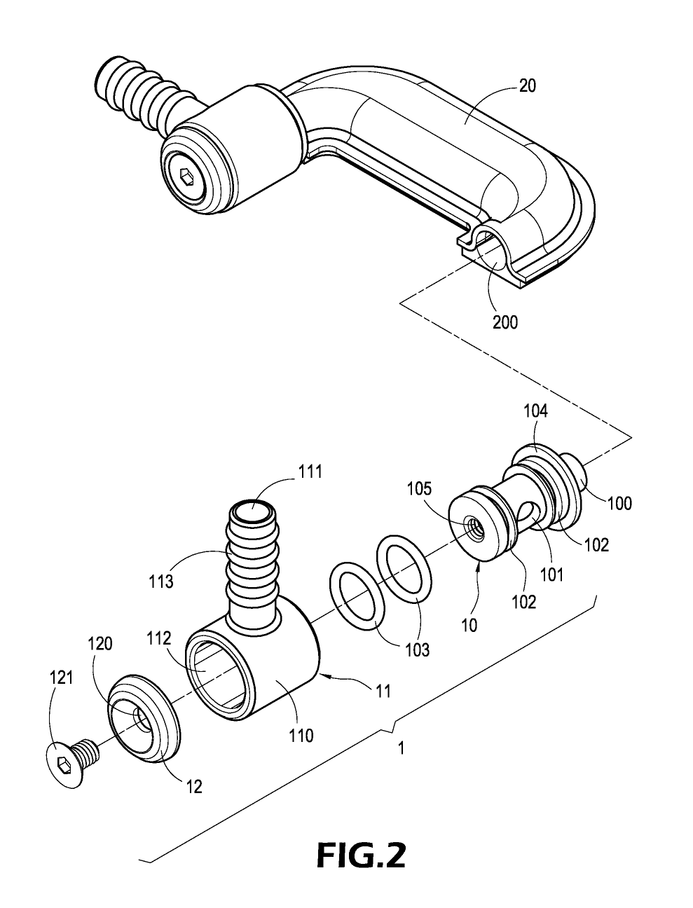

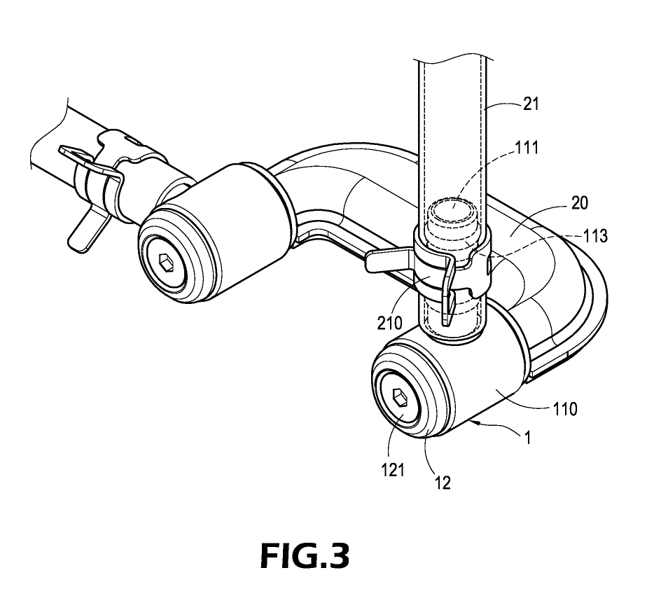

FIG. 1 is a perspective view showing that the present invention is applied to a water-cooling circulation system. FIGS. 2 and 3 are an exploded perspective view and an assembled perspective view of the present invention, respectively. The present invention provides a pipe connector, which can be applied to a water-cooling circulation system 2 and assembled between an intake/drain port 200 (or other intake/drain port) of the water-cooling circulation system 2 and the cold water pipeline 21. The pipe connector 1 is constituted of a pipe-connecting piece 10, a pipe-covering piece 11 and a sealing piece 12.

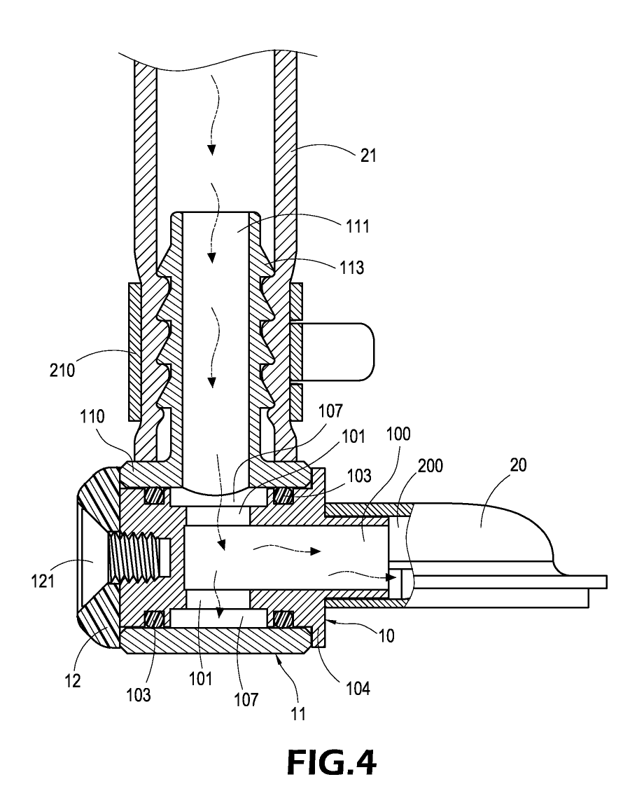

The pipe-connecting piece 10 is hollow in its interior to allow the liquid such as cold water to flow therethrough. On end of the pipe-connecting piece is closed and the other end thereof has a first connecting port 100 (FIG. 4) for communicating with its interior. The first connecting port 100 is connected face-to-face with the intake/drain port 200 of the cooling plate 20 and can be further fixedly welded thereto. The pipe-connecting piece 10 is further provided with at least one through hole 101. The through hole 101 is also in communication with the interior of the pipe-connecting piece 10. The pipe-connecting piece 10 is recessed to provide with two annular grooves 102. The two annular grooves 102 are provided at an interval with the through hole 101 disposed therebetween. A leakage-proof washer 103 is inserted into each annular groove 102. Further, the pipe-connecting piece 10 is provided with a stopping ring 104 adjacent to the outer periphery of the first connecting port 100.

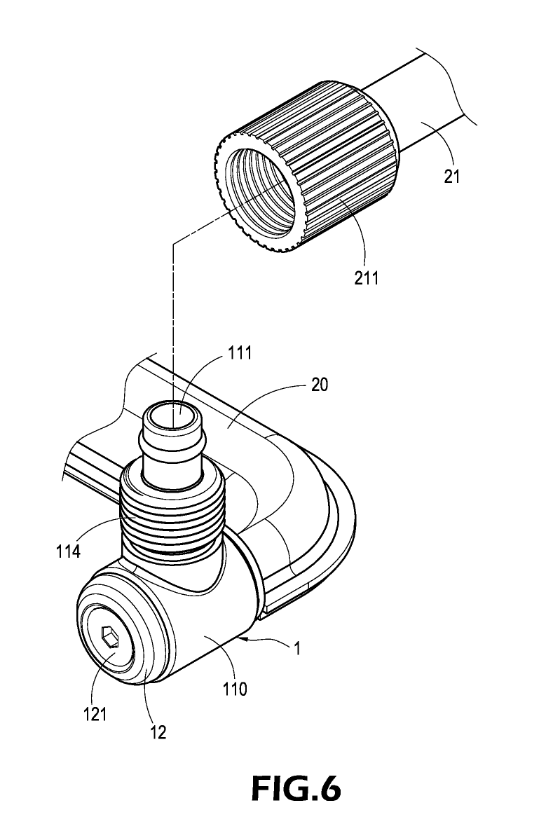

The pipe-covering piece 11 has an annular sheath 110 and a second connecting port 111 provided upright on the outer wall of the annular sheath 110. The annular sheath 110 has a sheath hole 112 penetrating through both ends thereof, so that the closed end of the pipe-connecting piece 10 can be inserted into the sheath hole 112. One end of the pipe-covering piece 11 abuts against the stopping ring 104 of the pipe-connecting piece 10, so that the pipe-covering piece 11 is covered on the outside of the pipe-connecting piece 10. Further, the inner wall of the pipe-covering piece 11 abuts tightly onto the two leakage-proof washers 103, as shown in FIG. 4. Further, the second connecting port 111 of the pipe-covering piece 11 is in communication with the sheath hole 112. When the pipe-covering piece 11 is covered on the outside of the pipe-connecting piece 10, the second connecting port 111 is then brought into communication with the interior of the pipe-connecting piece 10 via the sheath hole 112. Alternatively, as long as the second connecting port 111 corresponds to the through hole 101 of the pipe-connecting piece 10, the second connecting port 111 can be connected face-to-face with the cold water pipeline 21. In the present embodiment, the outside of the second connecting port 111 is provided with a plurality of annular ribs 113 arranged axially at intervals. With this arrangement, after the cold water pipeline 21 is provided on the second connecting port 111, a tightening band 210 (FIG. 3) is used to apply a tightening force to form a tight connection therebetween, thereby to achieve the leakage-proof effect. Further, as shown in FIG. 6, in another embodiment of the present invention, the second connecting port 111 is provided with an external thread 114 and the pipe hole of the cold water pipeline 21 is provided with a nut 211. With the above arrangement, the nut 211 is threaded onto the external thread 114 of the second connecting port 111, thereby to achieve the same effect.

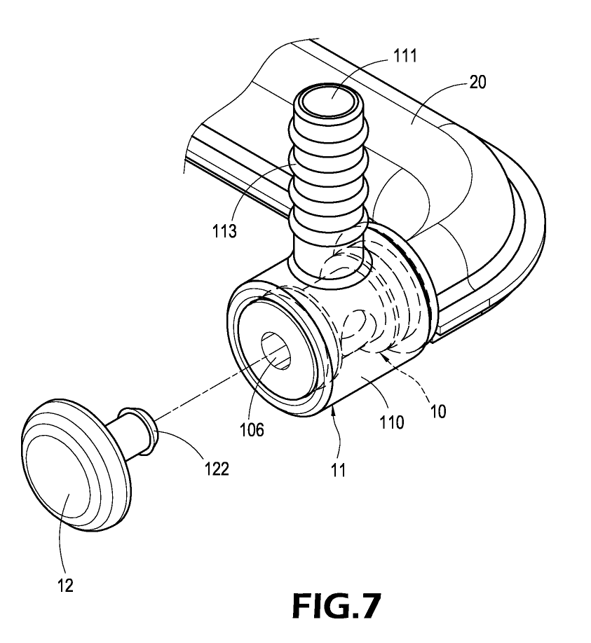

The sealing piece 12 is covered to the outside of one end of the sheath hole 112 of the pipe-covering piece 11 and located at one end away from the first connecting port 100 of the pipe-connecting piece 10, thereby to cooperate with the stopping ring 104 of the pipe-connecting piece 10 to position the pipe-covering piece 11 onto the pipe-connecting piece 10. In the present embodiment, the face of the closed end of the pipe-connecting piece 10 is provided with a screw hole 105 thereon. Further, the sealing piece 12 is also provided with a penetrating hole 120 corresponding to the screw hole. After a locking element 121 (such as screw) penetrates through the penetrating hole 120 of the sealing piece 12, the locking element can be locked on the screw hole 105 of the pipe-connecting piece 10. In another embodiment of the present invention, as shown in FIG. 7, the sealing piece 12 is provided with a clasping portion 122 thereon. Further, the face of the closed end of the pipe-connecting piece 10 is provided with a clasping hole 106 corresponding to the clasping portion. With the engagement between the clasping portion 122 and the clasping hole 106, the sealing piece 12 can be fixed onto the pipe-connecting piece 10. As a result, the sealing piece 12 can be detachably provided on the outside of one end of the sheath hole 112 of the pipe-covering piece 11, so that it can be easily detached to change the pipe connector 1 to correspond to different amount of water flow or it is convenient for the future repair.

Therefore, with the above construction, the pipe connector of the present invention can be achieved.

As shown in FIG. 4, when the cold water enters the cold water pipeline 21, it can flow into the pipe connector 1 through the second connecting port 111 and then flow into the cooling plate 20 through the first connecting port 100. On the contrary, the cold water is drained out via another intake/drain port 200 of the cooling plate 20 in a reverse order, so that the cold water can generate a heat-dissipating effect upon contacting with the heat source.

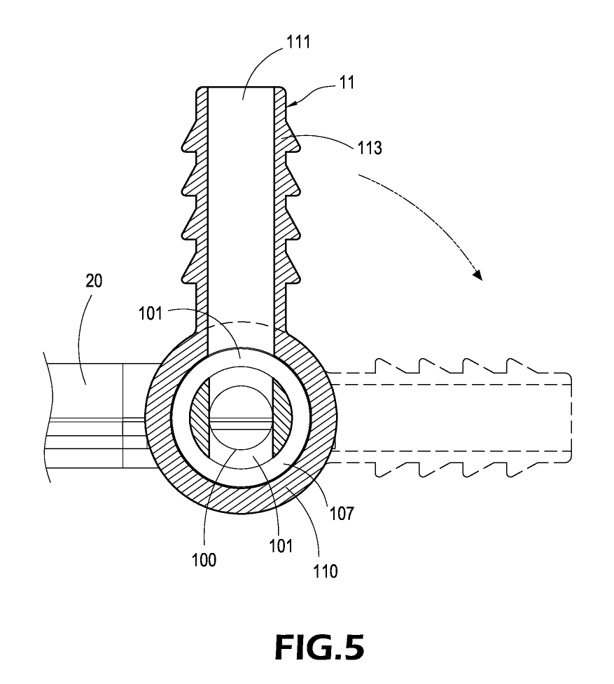

With reference to FIG. 5, since the pipe-covering piece 11 is covered on the outside of the pipe-connecting piece 10 and the sheath hole 112 of the pipe-covering piece 11 is a circular hole, the pipe-covering piece 11 is allowed to rotate 360 degrees on the pipe-connecting piece 10, thereby to redirect the second connecting port 111 toward other orientations and in turn change the orientation of the cold water pipeline 21. As a result, the whole arrangement of the water-cooling circulation system 2 will not be restricted by the orientation of the pipeline. At the same time, in order to keep the communication between the second connecting port 111 and the interior of the pipe-connecting piece 10 upon the rotation of the pipe-covering piece 11, an annular passage is formed between the pipe-connecting piece 10 and the pipe-covering piece 11. Further, the annular passage 107 is in communication with the second connecting port 111 and the through hole 101 of the pipe-connecting piece 10.

According to the above, the present invention has achieved the desired effects and solved the drawbacks of prior art. Further, the present invention indeed has novelty and inventive steps, and thus conforms to the requirements for a utility model patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A pipe connector, comprising:
a pipe-connecting piece hollowed in an interior thereof and having a first connecting port for communicating with the interior, the pipe-connecting piece provided with at least one through hole for communicating with the interior, and two leakage-proof washers provided at an interval with the through hole disposed therebetween;
a pipe-covering piece having an annular sheath and a second connecting port provided on an outer wall of the annular sheath, the annular sheath covered on the pipe-connecting piece to allow an inner wall thereof to tightly abut against the two leakage-proof washers and to allow the second connecting port to communicate with the interior of the pipe-connecting piece; and
a sealing piece detachably provided on outside of one end of the pipe-covering piece and located at one end away from the first connecting port of the pipe-connecting piece.

2. The pipe connector according to claim 1, wherein the pipe-connecting piece is recessed to provide with two annular grooves, the two annular grooves are provided at an interval with the through hole disposed therebetween, and the two leakage-proof washers are inserted into the two annular grooves, respectively.

3. The pipe connector according to claim 1, wherein the pipe-connecting piece is provided with a stopping ring adjacent to an outer periphery of the first connecting port, and one end of the pipe-covering piece abuts against the stopping ring.

4. The pipe connector according to claim 1, wherein an annular passage is formed between the pipe-connecting piece and the pipe-covering piece, and the annular passage is communicated with the through hole of the pipe-connecting piece and the second connecting port.

5. The pipe connector according to claim 1, wherein the through hole of the pipe-connecting piece corresponds to the second connecting port of the pipe-covering piece.

6. The pipe connector according to claim 1, wherein the annular sheath of the pipe-covering piece has a sheath hole penetrating both ends thereof for covering the annular sheath on the pipe-connecting piece.

7. The pipe connector according to claim 6, wherein the sheath hole is a circular hole.

8. The pipe connector according to claim 1, wherein the sealing piece is provided with a penetrating hole thereon, an end face of the pipe-connecting piece is provided with a screw hole to correspond to the penetrating hole, and a locking element penetrates through the penetrating hole and is locked onto the screw hole.

9. The pipe connector according to claim 1, wherein the sealing piece is provided with a clasping portion thereon, an end face of the pipe-connecting piece is provided with a clasping hole to correspond to the clasping portion, and the clasping portion and the clasping hole are clasped with each other.

10. A pipe connector, comprising:
a pipe-connecting piece hollowed in an interior thereof and having a first connecting port for communicating with the interior, the pipe-connecting piece provided with at least one through hole for communicating with the interior, and two leakage-proof washers provided at an interval with the through hole disposed therebetween;
a pipe-covering piece having an annular sheath and a second connecting port provided on an outer wall of the annular sheath, the annular sheath having a circular sheath hole, the sheath hole covered on the pipe-connecting piece to allow an inner wall of the annular sheath to tightly abut against the two leakage-proof washers and to allow the second connecting port to communicate with the interior of the pipe-connecting piece; and
a sealing piece provided on outside of one end of the pipe-covering piece and located at one end away from the first connecting port of the pipe-connecting piece.

11. The pipe connector according to claim 10, wherein the pipe-connecting piece is recessed to provide with two annular grooves, the two annular grooves are provided at an interval with the through hole disposed therebetween, and the two leakage-proof washers are inserted into the two annular grooves, respectively.

12. The pipe connector according to claim 10, wherein the pipe-connecting piece is provided with a stopping ring adjacent to an outer periphery of the first connecting port, and one end of the pipe-covering piece abuts against the stopping ring.

13. The pipe connector according to claim 10, wherein an annular passage is formed between the pipe-connecting piece and the pipe-covering piece, and the annular passage is communicated with the through hole of the pipe-connecting piece and the second connecting port.

14. The pipe connector according to claim 10, wherein the through hole of the pipe-connecting piece corresponds to the second connecting port of the pipe-covering piece.

15. The pipe connector according to claim 10, wherein the sealing piece is provided with a penetrating hole thereon, an end face of the pipe-connecting piece is provided with a screw hole to correspond to the penetrating hole, and a locking element penetrates through the penetrating hole and is locked onto the screw hole.

16. The pipe connector according to claim 10, wherein the sealing piece is provided with a clasping portion thereon, an end face of the pipe-connecting piece is provided with a clasping hole to correspond to the clasping portion, and the clasping portion and the clasping hole are clasped with each other.
